(19) United States
(12) Patent Application Publication
(10) Pub. No.: US 2016/0271495 A1
(43) Pub. Date: Sep. 22, 2016

(54) METHOD AND SYSTEM OF CREATING AND ENCODING VIDEO GAME SCREEN IMAGES FOR TRANSMISSION OVER A NETWORK

(71) Applicant: SQUARE ENIX HOLDINGS CO., LTD., Tokyo (JP)

(72) Inventor: Cyril PERRIN, Antony (FR)

(73) Assignee: SQUARE ENIX HOLDINGS CO., LTD., Tokyo (JP)

(21) Appl. No.: 14/442,835

(22) PCT Filed: Jan. 9, 2014
(86) PCT No.: PCT/JP2014/050724

§ 371 Date: May 14, 2015

(51) Int. Cl. A63F 13/355; A63F 13/537; A63F 13/803; H04N 19/23; H04N 19/154

(52) U.S. Cl. CPC A63F 13/355; H04N 19/23; H04N 19/154; A63F 13/803; A63F 13/537

(57) ABSTRACT

A method of creating and encoding images, which comprises identifying a set of objects in a scene to be rendered; rendering the objects into at least two groups of images. Each of the groups of images comprises at least one image respective to that group. The method further comprises encoding the images in each group in accordance with an encoding process common to that group, and outputting the encoded images via an interface. Also provided is a non-transitory computer-readable medium storing instructions for execution by at least one processor of at least one computing device, wherein execution of the instructions by the at least one processor of the at least one computing device causes the at least one computing device to implement the aforementioned method. Also provided is at least one video game server with components adapted to perform the aforementioned method.

### FIELD OF THE INVENTION

The present invention relates generally to the delivery of video game services over a network and, in particular, to a method and system for encoding and transmitting images associated with such video games.

### BACKGROUND

Video games have become a common source of entertainment for virtually every segment of the population. The video game industry has seen considerable evolution, from the introduction of stand-alone arcade games, to home-based computer games and the emergence of games made for specialized consoles. Democratization of the Internet then enabled the next major development, namely cloud-based gaming systems. In a cloud-based gaming system, a player can utilize an ordinary Internet-enabled appliance such as a smartphone or tablet to connect to a video game server on the Internet. The video game server starts a session for the player and renders images for the player based on selections (e.g., moves, actions) made by the player and other attributes of the game. The images are delivered to the player's device over the Internet, and are reproduced on the display. In this way, players from anywhere in the world can play a video game without the use of specialized video game consoles, software or graphics processing hardware.

One of the consequences of performing rendering at a centralized location is the relatively large volume of (primarily video) information that needs to be transmitted to the client device, at a frame rate that allows images of satisfactory quality and fluidity to be displayed for the user. To reduce bandwidth requirements, it is customary to employ one of many existing video codecs, which can significantly compress video data using specially designed compression algorithms.

However, it is well known that at higher compression ratios, which use less bandwidth, the quality of the image reproduced at the client device will suffer. On the other hand, a high-quality user experience comes at the expense of increased usage of network resources—particularly bandwidth—which may be scarce or expensive.

Thus, the intense graphical nature of video gaming, particularly when servicing multiple client devices over the Internet, continues to represent a challenge for cloud-based video game service providers.

### SUMMARY OF THE INVENTION

Various non-limiting aspects of the invention are set out in the following clauses:
1. A method of creating and encoding images, comprising:
   identifying a set of objects in a scene to be rendered;
   rendering the objects into at least two groups of images, each of the groups of images comprising at least one image respective to that group;
   encoding the images in each group in accordance with an encoding process common to that group; and
   outputting the encoded images via an interface.
2. The method defined in clause 1, wherein the groups of images include a first group of at least one first image and a second group of at least one second image, and wherein the encoding process used to encode the at least one first image is different from the encoding process used to encode the at least one second image.
3. The method defined in clause 1, wherein the groups of images include a first group and a second group, and wherein the encoding process used to encode the images in the first group and the encoding process used to encode the images in the second group are associated with different levels of image quality.
4. The method defined hi clause 1, wherein the groups of images include a first group and a second group, and wherein the encoding process used to encode the images in the first group and the encoding process used to encode the images hi the second group are selected from the set consisting of: PNG, H.264 lossless, JPEG2000 lossless, H.264, DiVX and WMV.
5. The method defined in clause 1, wherein the groups of images include a first group of at least one first image and a second group of at least one second image, wherein rendering the objects comprises rendering a first subset of the objects into the at least one first image and rendering a second subset of the objects into the at least one second image.
6. The method defined in clause 5, wherein the objects in the first subset of objects are associated with a first object type and wherein the objects in the second subset of objects are associated with a second object type different from the first object type.
7. The method defined in clause 5, wherein the objects in the first subset of objects are associated with an object type in a first set of object types and wherein the objects in the second subset of objects are associated with an object type in a second set of object types.
8. The method defined in clause 7, wherein the first and second sets of object types include different object types.
9. The method defined in clause 1, wherein the groups of images include a first group of a plurality of first images and a second group of at least one second image, wherein rendering the objects comprises rendering individual objects into corresponding ones of the first images.
10. The method defined in clause 9, wherein the objects rendered into corresponding ones of the first images are associated with a common object type that is unique to the first subset.
11. The method defined in any one of clauses 6, 7 and 10, wherein the object type of a given one of the objects is indicative of an image quality requirement of the given one of the objects.
12. The method defined in clause 11, wherein the image quality requirement of the given one of the objects is selected from the group consisting of: high, medium and low.
13. The method defined in any one of clauses 6, 7 and 10, wherein the object type of a given one of the objects is indicative of an on-screen position of the given one of the objects.
14. The method defined in clause 13, wherein the on-screen position of the given one of the objects is selected from the group consisting of: heads up display (HUD) and on-screen action.
15. The method defined in any one of clauses 6, 7 and 10, wherein the object type of a given one of the objects is indicative of an in-game role of the given one of the objects.
16. The method defined in clause 16, wherein the in-game role of the given one of the objects is selected from the group consisting of: character/avatar, sky, building, cloud, fire, vegetation and scoreboard.
17. The method defined in any one of clauses 11, 13 and 15, wherein the object type is stored as a field in a memory, the method further comprising: accessing the memory to retrieve the object type associated with each of the objects.
18. The method defined in clause 1, wherein at least one of the groups comprises a plurality of images, the method further comprising:
   combining at least two of the images prior to encoding, such that the number of images after encoding is less than the number of images before encoding,
19. The method defined in any one of clauses 1 to 18, implemented by at least one server executing a video game, wherein the images are game screens of the video game.
20. The method defined in any one of clauses 1 to 19, wherein to render an object, the method further comprises retrieving object information from a memory.
21. The method defined in clause 20, wherein to render an object, the method further comprises interacting with a graphics processing unit (GPU),
22. The method defined in clause 1, wherein outputting the encoded images via the interface comprises sending the encoded images towards a client device over a network.
23. The method defined in clause 1, wherein outputting the encoded images via the interface comprises sending the encoded images towards a client device over the Internet.
24. A non-transitory computer-readable medium storing instructions for execution by at least one processor of at least one computing device, wherein execution of the instructions by the at least one processor of the at least one computing device causes the at least one computing device to implement a method of creating and encoding images, comprising:
   identifying a set of objects in a scene to be rendered;
   rendering the objects into at least two groups of images, each of the groups of images comprising at least one image respective to that group;
   encoding the images in each group in accordance with an encoding process common to that group; and
   outputting the encoded images via an interface.
25. The computer-readable medium defined in clause 24, wherein the groups of images include a first group of at least one first image and a second group of at least one second image, and wherein the encoding process used to encode the at least one first image is different from the encoding process used to encode the at least one second image.
26. The computer-readable medium defined in clause 24, wherein the groups of images include a first group and a second group, and wherein the encoding process used to encode the images in the first group and the encoding process used to encode the images in the second group are associated with different levels of image quality.
27. The computer-readable medium defined in clause 24, wherein the groups of images include a first group and a second group, and wherein the encoding process used to encode the images in the first group and the encoding process used to encode the images in the second group are selected from the set consisting of: PNG, H.264 lossless, JPEG2000 lossless, H.264, DiVX and WMV.
28. The computer-readable medium defined in clause 24, wherein the groups of images include a first group of at least one first image and a second group of at least one second image, wherein rendering the objects comprises rendering a first subset of the objects into the at least one first image and rendering a second subset of the objects into the at least one second image,
29. The computer-readable medium defined in clause 28, wherein the objects in the first subset of objects are associated with a first object type and wherein the objects in the second subset of objects are associated with a second object type different from the first object type.
30. The computer-readable medium defined in clause 28, wherein the objects in the first subset of objects are associated with an object type in a first set of object types and wherein the objects in the second subset of objects are associated with an object type in a second set of object types.
31. The computer-readable medium defined in clause 30, wherein the first and second sets of object types include different object types.
32. The computer-readable medium defined in clause 24, wherein the groups of images include a first group of a plurality of first images and a second group of at least one second image, wherein rendering the objects comprises rendering individual objects into corresponding ones of the first images.
33. The computer-readable medium defined in clause 32, wherein the objects rendered into corresponding ones of the first images are associated with a common object type that is unique to the first subset.
34. The computer-readable medium defined in any one of clauses 29, 30 and 33, wherein the object type of a given one of the objects is indicative of an image quality requirement of the given one of the objects.
35. The computer-readable medium defined in clause 34, wherein the image quality requirement of the given one of the objects is selected from the group consisting of: high, medium and low,
38. The computer-readable medium defined in any one of clauses 29, 30 and 33, wherein the object type of a given one of the objects is indicative of an on-screen position of the given one of the objects,
37. The computer-readable medium defined in clause 36, wherein the on-screen position of the given one of the objects is selected from the group consisting of: heads up display (HUD) and on-screen action.
38. The computer-readable medium defined in any one of clauses 29, 30 and 33, wherein the object type of a given one of the objects is indicative of an in-game role of the given one of the objects,
39. The computer-readable medium defined in clause 36, wherein the in-game role of the given one of the objects is selected from the group consisting of: character/avatar, sky, budding, cloud, fire, vegetation and scoreboard.
40. The computer-readable medium defined in any one of clauses 34, 36 and 38, wherein the object type is stored as a field in a memory, the method further comprising:
   accessing the memory to retrieve the object type associated with each of the objects.
41. The computer-readable medium defined in clause 24, wherein at least one of the groups comprises a plurality of images, the method further comprising:
   combining at least two of the images prior to encoding, such that the number of images after encoding is less than the number of images before encoding.
42. The computer-readable medium defined in any one of clauses 24 to 41, wherein the images are game screens of a video game.
43. The computer-readable medium defined in any one of clauses 24 to 42, wherein to render an object, the method further comprises retrieving object information from a memory.
44. The computer-readable medium defined in clause 43, wherein to render an object, the method further comprises interacting with a graphics processing unit (GPU).
45. The computer-readable medium defined in clause 24, wherein outputting the encoded images via the interface comprises sending the encoded images towards a client device over a network,
46. The computer-readable medium defined in clause 24, wherein outputting the encoded images via the interface comprises sending the encoded images towards a client device over the Internet.
47. At least one video game server, comprising;
   an interface for communication with at least one client device over a network;
   a memory;
   at least one processing unit configured to;
      identify a set of objects in a scene to be rendered for at least one client device;
      render the objects into at least two groups of images stored in the memory, each of the groups of images comprising at least one image respective to that group;
      encode the images in each group in accordance with an encoding process common to that group; and
      output the encoded images via the interface,
48. The at least one video game server of clause 47, wherein the at least one video game server comprises a plurality of servers, wherein at least a first one of the servers is configured to identify the set of objects and wherein at least a second one of the servers is configured to render the objects into the at least two groups of images,
49. The at least one video game server of clause 48, wherein the at least a second one of the servers is also configured to encode the images and to output the encoded images.
50. The at least one video game server of clause 48 or clause 49, wherein the at least a second one of the servers comprises at least one graphics processing unit (GPU) configured to render the objects into the at least two groups of images.
51. The at least one video game server defined in clause 47, wherein the groups of images include a first group of at least one first image and a second group of at least one second image, and wherein the encoding process used to encode the at least one first image is different from the encoding process used to encode the at least one second image.
52. The at least one video game server defined in clause 47, wherein the groups of images include a first group and a second group, and wherein the encoding process used to encode the images in the first group and the encoding process used to encode the images in the second group are associated with different levels of image quality.
53. The at least one video game server defined in clause 47, wherein the groups of images include a first group and a second group, and wherein the encoding process used to encode the images in the first group and the encoding process used to encode the images in the second group are selected from the set consisting of: PNG, H.264 lossless, JPEG2000 lossless, H.264, DiVX and MN.
54. The at least one video game server defined in clause 47, wherein the groups of images include a first group of at least one first image and a second group of at least one second image, wherein to render the objects the at least one processing unit is configured to render a first subset of the objects into the at least one first image and to render a second subset of the objects into the at least one second image,
55. The at least one video game server defined in clause 54, wherein the objects in the first subset of objects are associated with a first object type and wherein the objects in the second subset of objects are associated with a second object type different from the first object type.
56. The at least one video game server defined in clause 54, wherein the objects in the first subset of objects are associated with an object type in a first set of object types and wherein the objects in the second subset of objects are associated with an object type in a second set of object types.
57. The at least one video game server defined in clause 56, wherein the first and second sets of object types include different object types,
58. The at least one video game server defined in clause 47, wherein the groups of images include a first group of a plurality of first images and a second group of at least one second image, wherein to render the objects the at least one processing unit is configured to render individual objects into corresponding ones of the first images.
59. The at least one video game server defined in clause 58, wherein the objects rendered into corresponding ones of the first images are associated with a common object type that is unique to the first subset,
60. The at least one video game server defined in any one of clauses 55, 56 and 59, wherein the object type of a given one of the objects is indicative of an image quality requirement of the given one of the objects.
61. The at least one video game server defined in clause 60, wherein the image quality requirement of the given one of the objects is selected from the group consisting of: high, medium and low.
62. The at least one video game server defined in any one of clauses 55, 56 and 59, wherein the object type of a given one of the objects is indicative of an on-screen position of the given one of the objects.
63. The at least one video game server defined in clause 62, wherein the on-screen position of the given one of the objects is selected from the group consisting of: heads up display (HUD) and on-screen action.
64. The at least one video game server defined in any one of clauses 55, 56 and 59, wherein the object type of a given one of the objects is indicative of an in-game role of the given one of the objects.
65. The at least one video game server defined in clause 64, wherein the in-game role of the given one of the objects is selected from the group consisting of: character/avatar, sky, building, cloud, fire, vegetation and scoreboard.
66. The at least one video game server defined in any one of clauses 60, 62 and 64, the object type is stored as a field in the memory, the at least one processing unit being configured to access the memory to retrieve the object type associated with each of the objects.
67. The at least one video game server defined in clause 47, wherein at least one of the groups comprises a plurality of images, the at least one processing unit being further configured to combine at least two of the images prior to encoding, such that the number of images after encoding is less than the number of images before encoding.
68. The at least one video game server defined in any one of clauses 47 to 67, wherein the images are game screens of a video game.
69. The at least one video game server defined in any one of clauses 47 to 68, wherein to render an object, the at least one processing unit retrieving object information from the memory.
70. The at least one video game server defined in clause 69, wherein to render an object, the at least one processing unit is configured to interact with a graphics processing unit (GPU).
71. The at least one video game server defined in clause 47, wherein the encoded images are sent via the interface towards a client device over a network.
72. The at least one video game server defined in clause 47, wherein the encoded images are sent via the interface towards a client device over the Internet.

These and other aspects and features of the present invention will now become apparent to those of ordinary skill in the art upon review of the following description of specific embodiments of the invention in conjunction with the accompanying drawings.

### BRIEF DESCRIPTION OF THE DRAWINGS

In the accompanying drawings:

FIG. 1 is a block diagram of a video game system architecture, according to a non-limiting embodiment of the present invention;

FIG. 2 is a block diagram showing various functional modules of a server system used in the video game system architecture of FIG. 1, according to a non-limiting embodiment of the present invention;

FIG. 3 is a flowchart showing detailed execution of a main processing loop executed by the server system, in accordance with a non-limiting embodiment of the present invention;

FIGS. 4A, 4B, 5A and 5B schematically illustrate operation of the rendering and encoding steps of the main processing loop, in accordance with various non-limiting embodiments of the present invention;

FIG. 6 is a flowchart showing steps taken by a client device to decode, combine and display received images, in accordance with various non-limiting embodiment of the present invention; and

FIG. 7 schematically illustrates the result of using different encoding and decoding compression algorithms for different object types, by way of non-limiting example.

### DETAILED DESCRIPTION

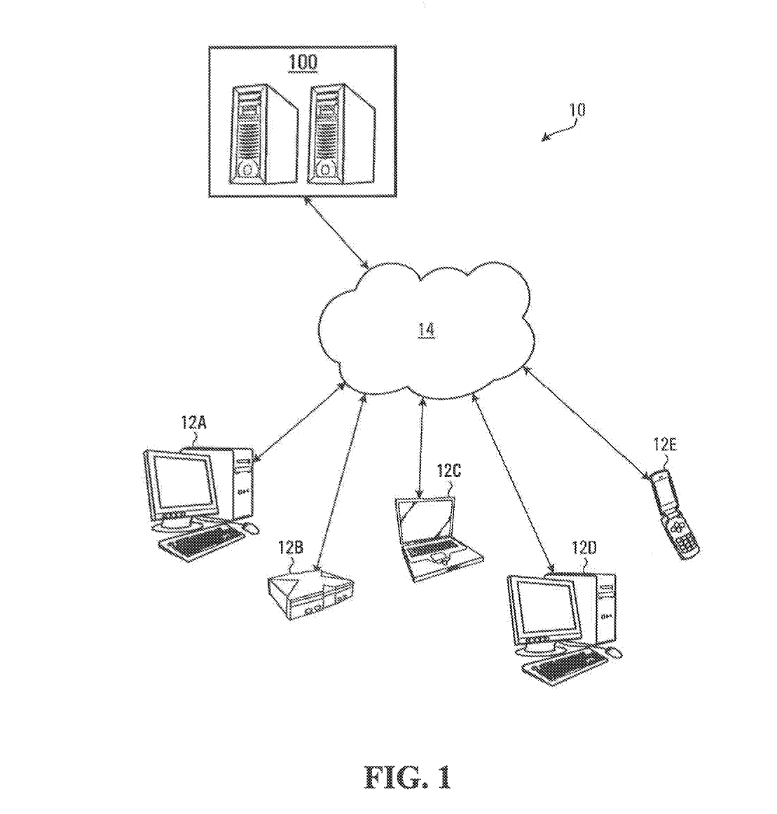

FIG. 1 shows an architecture of a video game system 10 according to a non-limiting embodiment of the present invention, in which client devices 12a-e are connected to a server system 100 (or “server arrangement”) across a network 14 such as the Internet or a private data network. In a non-limiting embodiment, the server system 100 may be configured so as to enable users of the client devices 12a-e to play a video game, either individually or collectively. A video game may include a game that is played purely for entertainment, education, sport, with or without the possibility of monetary gain (gambling). The server system 100 may comprise a single server or a cluster of servers connected through, for example, a virtual private network (VPN) and/or a data center. Individual servers within the cluster may be configured to carry out specialized functions. For example, one or more servers may be primarily responsible for graphics rendering.

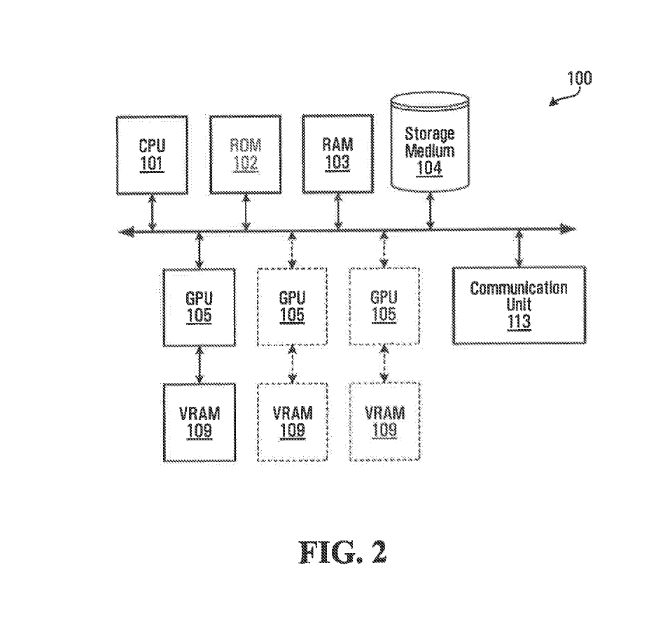

With reference to FIG. 2, the server system 100 may include one or more servers, each with a GPU 101. In a non-limiting embodiment, the GPU 101 may load video game program instructions into a local memory 103 (e.g., RAM) and then may execute them. In a non-limiting embodiment, the video game program instructions may be loaded into the local memory 103 from a ROM 102 or from a storage medium 104. The ROM 102 may be, for example, a programmable non-volatile memory which, in addition to storing the video game program instructions, may also store other sets of program instructions as well as data required for the operation of various modules of the server system 100. The to storage medium 104 may be, for example, a mass storage device such as an HDD detachable from the server system 100. The storage medium 104 may also serve as a database for storing information about participants involved the video game, as well as other kinds of information that may be required to generate output for the various participants in the video game.

The video game program instructions may include instructions for monitoring/controlling gameplay and for controlling the rendering of game screens for the various participants in the video game. The rendering of game screens may be executed by invoking one or more specialized processors referred to as graphics processing units (GPUs) 105. Each GPU 105 may be connected to a video memory 109 (e.g., VRAM), which may provide a temporary storage area for rendering a game screen. When performing rendering, data for an object in three-dimensional space may be loaded into a cache memory (not shown) of the GPU 105. This data may be transformed by the GPU 105 into data in two-dimensional space, which may be stored in the VRAM 109. Although each GPU 105 is shown as being connected to only one video memory 109, the number of video memories 109 connected to the GPU 105 may be any arbitrary number. It should also be appreciated that in a distributed rendering implementation, the GPU 101 and the GPUs 105 may be located on separate computing devices.

Also provided in the server system 100 is a communication unit 113, which may implement a communication interface. The communication unit 113 may exchange data with the client devices 12a-e over the network 14. Specifically, the communication unit 113 may receive user inputs from the client devices 12a-e and may transmit data to the client devices 12a-e. As will be seen later on, the data transmitted to the client devices 12a-e may include encoded images of game screens or portions thereof. Where necessary or appropriate, the communication unit 113 may convert data into a format compliant with a suitable communication protocol.

Turning now to the client devices 12a-e, their configuration is not particularly limited. In some embodiments, one or more of the client devices 12a-e may be, for example, a PC, a home game machine (console such as XBOX™, PS3™ Wii™, etc.), a portable game machine, a smart television, a set-top box (STB), etc. In other embodiments, one or more of the client devices 12a-e may be a communication or computing device such as a mobile phone, a PDA, or a tablet.

The client devices 12a-e may be equipped with input devices (such as a touch screen, a keyboard, a game controller, a joystick, etc.) to allow users of the client devices 12a-e to provide input and participate in the video game. In other embodiments, the user of a given one of the client devices 12a-e may produce body motion or wave an external object; these movements are detected by a camera or other sensor (e.g., Kinect™) while software operating within the client device attempts to correctly guess whether the user intended to provide input to the client device and, if so, the nature of such input. In addition, each of the client devices 12a-e may include a display for displaying game screens, and possibly also a loudspeaker for outputting audio. Other output devices may also be provided, such as an electro-mechanical system to induce motion, and so on.

### Game Screen Creation by Server System

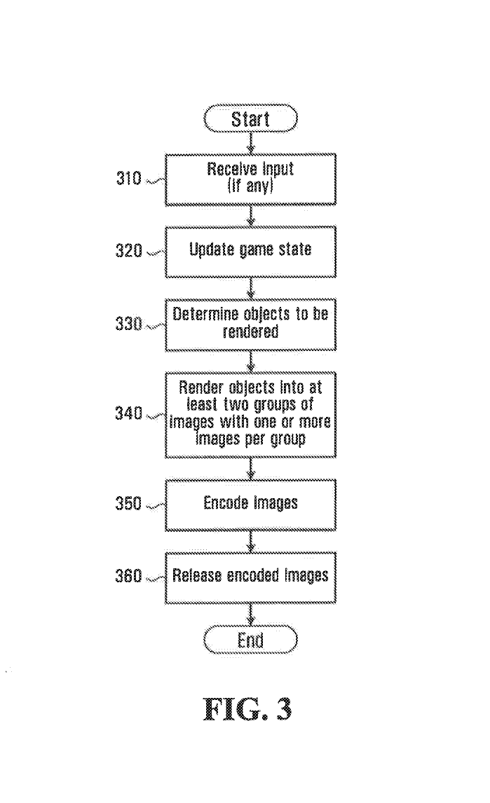

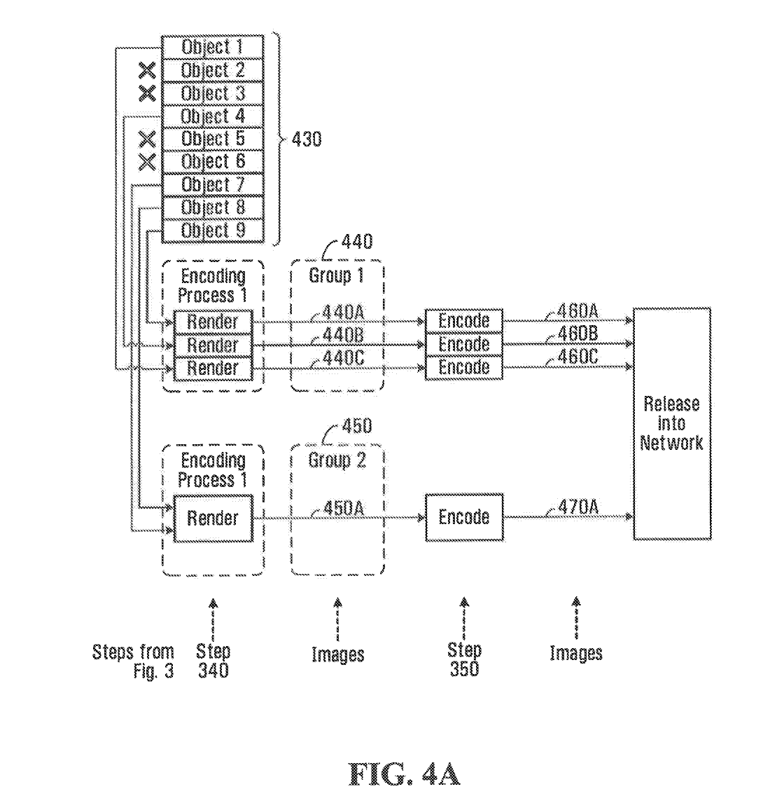

Reference is now made to FIG. 3, which conceptually illustrates the steps in a main processing loop (or main game loop) of the video game program implemented by the server system 100. The main game loop may be executed for each participant in the game, thereby causing an image to be rendered for each of the client devices 12a-e. To simplify the description, the embodiments to be described below will assume that the main game loop is executing for a participant denoted “participant Y”. However, it should be understood that an analogous main game loop also executes for each of the other participants in the video game. In addition, a “participant” is meant to encompass players (who control active characters or avatars) and spectators (who simply observe other players' gameplay but otherwise do not control an active character in the game).

The main game loop may include steps 310 to 360, which are described below in further detail, in accordance with a non-limiting embodiment of the present invention. The main game loop for each participant (including participant Y) continually executes on a frame-by-frame basis. Since the human eye perceives fluidity of motion when approximately at least twenty-four (24) frames are presented per second, the main game loop may execute at least 24 times per second, such as 30 or 60 times per second, for each participant (including participant Y). However, this is not a requirement of the present invention.

At step 310, inputs are received. This step may not be executed for certain passes through the main game loop. The inputs, if there are any, may be received from various client devices 12a-e through a back channel over the network 14. These inputs may be the result of the client devices 12a-e detecting user actions, or they may be generated autonomously by the client devices 12a-e themselves. The input from a given client device may convey that the user of the client device wishes to cause a character under his or her control to move, jump, kick, turn, swing, pull, grab, etc. Alternatively or in addition, the input from a given client device may convey a menu selection made by the user of the client device in order to change one or more audio, video or gameplay settings, to load/save a game or to create or join a network session. Alternatively or in addition, the input from a given client device may convey that the user of the client device wishes to select a particular camera view (e.g., first-person or third-person) or reposition his or her viewpoint within the virtual world maintained by the video game program.

At step 320, the game state of the video game may be updated based at least in part on the inputs received at step 310 and other parameters. By “game state” is meant the state (or properties) of the various objects existing in the virtual world maintained by the video game program. These objects may include playing characters, non-playing characters and other objects. In the case of a playing character, properties that can be updated may include: position, strength, weapons/armor, lifetime left, special powers, speed/direction (velocity), animation, visual effects, energy, ammunition, etc. In the case of other objects (such as background, vegetation, buildings, vehicles, etc.), properties that can be updated may include the position, velocity, animation, damage/health, visual effects, etc. It should be appreciated that parameters other than user inputs can influence the above properties of the playing characters, nonplaying characters and other objects. For example, various timers (such as elapsed time, time since a particular event, virtual time of day, etc.) can have an effect on the game state of playing characters, non-playing characters and other objects. The game state of the video game may be stored in a memory such as the RAM 103 and/or the storage medium 104.

At step 330, the video game program determines the objects to be rendered for participant Y. Specifically, this step can include identifying those objects that are in the game screen rendering range for participant Y, also known as a “scene”. The game screen rendering range includes the portion of the game world that is currently visible from the perspective of participant Y, which will depend on the position and orientation of the camera for participant Y relative to the objects in the game world. To this end, a frustum can be applied to the game world, and the objects within than frustum are retained or marked. The frustum has an apex which is situated at the location of participant Y and a directionality also defined by the directionality of participant Y's gaze. This information may be part of the game state maintained in the RAM 103 and/or the storage element 104.

At step 340, the objects that were identified as being within the scene for participant Y are rendered into a plurality of groups of images, where each group includes one or more images. For example, the plurality of groups of images may include a first group of at least one first image and a second group of at least one second image. A first subset of the objects in the scene is rendered into images in the first group and a second subset of the objects in the scene is rendered into images in the second group. To be precise, each image in the first group is derived from one or more objects in the first subset of objects, whereas each image in the second group is derived from one or more objects in the second subset of objects. The case of two groups is used for ease of explanation, but it is of course possible to create more than two groups of images. Also, there are various ways of relating individual objects to images representing those objects, is some of which will be described later on.

At step 350, the rendered images are encoded, resulting in a set of encoded images. In a non-limiting example, each of the images in a given group (e.g., the first group or the second group) may be encoded in accordance with an encoding process for that group. In a non-limiting embodiment, an “encoding process” refers to the processing carried out by a video encoder (or codec) implemented by the server system 100. Optionally, two or more of images in the same group may be combined prior to encoding, such that the number of encoded images created for the group is less than the number of images rendered. In any event, the result of step 350 is the creation of a plurality of encoded images, with at least one encoded image having been created per group. In addition to data compression, the encoding process used to encode a particular image may or may not apply cryptographic encryption.

At step 360, the encoded images created at step 350 are released over the network 14. For example, step 360 may include the creation of packets, each having a header and a payload. The header may include an address of a client device associated with participant Y, while the payload may include the encoded images. In a non-limiting embodiment, the compression algorithm used to encode a given image may be encoded in the content of one or more packets that convey the given image. Other methods of transmitting the encoded images will occur to those of skill in the art.

### Examples of Implementation of Steps 340 and 350

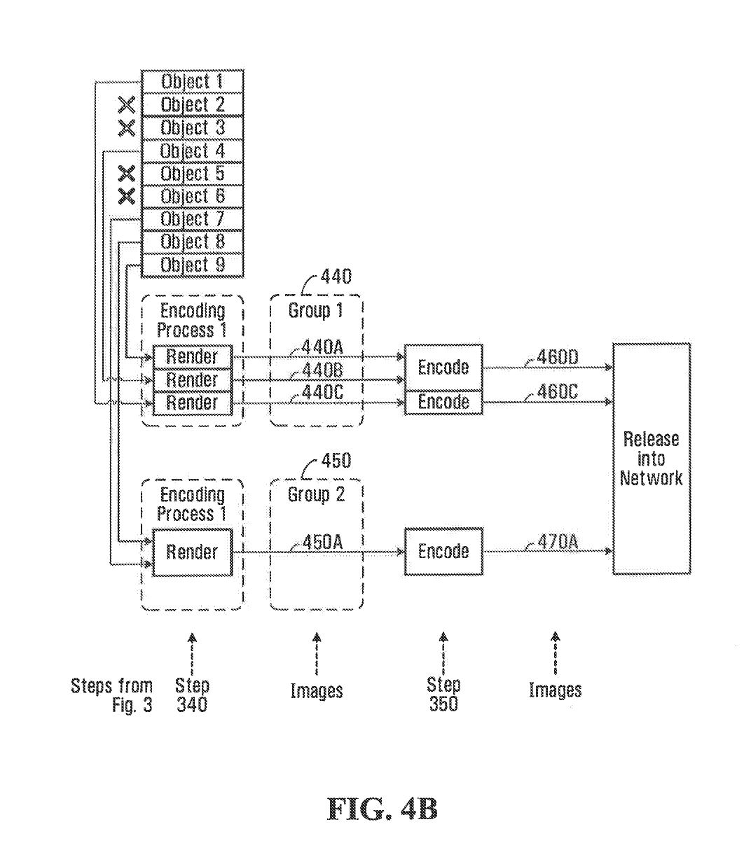

A more detailed example of implementation of steps 340 and 350 in accordance with a non-limiting embodiment of the present invention is now provided with reference to FIG. 4A, which shows an object list 430 with a plurality of entries. The example object list 430 is shown as including nine (9) entries, but of course this is not to be considered a limitation of the present invention. The object list 430 can be maintained in a memory such as RAM 103 or the storage medium 104, for example. Each entry in the object list 430 holds an identifier of a corresponding object pertaining to the video game. This may include objects that are in the virtual world of the video game, as well as objects that are part of the user interface. However, not all objects will be within the game screen rendering range of participant Y, for whom the main game loop is being executed.

For the purposes of the present example, it is assumed that prior execution of step 330 of the main game loop has revealed that among objects 1 through 9, only objects 1, 4, 7, 8 and 9 pertain to the present scene, i.e., are within the game screen rendering range for participant Y. As such, an “X” is depicted next to objects 2, 3, 5 and 6 in order to conceptually illustrate that these objects are not going to be rendered during the present pass through the main game loop.

Turning now to step 340, objects 1, 4, 7, 8 and 9 are rendered into a plurality of groups of images. While it is possible to have more than two groups, the present example utilizes two groups denoted 440, 450 for illustrative purposes. A first subset of the objects in the scene (namely, objects 1, 4 and 9) is rendered into images in group 440, and a second subset of the objects in the scene (namely, objects 7 and 8) is rendered into images in group 450. Rendering may refer to the transformation of 3-D coordinates of an object or group of objects into a displayable image, in accordance with the viewing perspective and prevailing lighting conditions. This can be achieved using any number of different algorithms, for example as described in Computer Graphics and Geometric Modelling: Implementation & Algorithms, Max K. Agoston, Springer-Verlag London Limited 2005, hereby incorporated by reference herein.

In the present case, there are three images 440A, 44013, 4400 in group 440 and one image 450A in group 450. Furthermore, each of the images 440A, 4408, 440C in group 440 is derived from a single object in the first subset, while image 450A is derived from all objects in the second subset. To be precise, images 440A, 44013, 4400 in group 440 represent objects 9, 4 and 1, respectively, while image 450A in group 450 represents both objects 7 and 8 together. Thus, it will be appreciated that an image in any given group may represent one object or more than one object.

Proceeding with step 350, the images 440A, 44013, 4400, 450A are encoded, resulting in a set of encoded images 460A, 460B, 460C, 470A, respectively. Each of the images in a given group is encoded in accordance with the encoding process common to that group. Thus, each of images 440A, 4408, 4400 in group 440 is encoded in accordance with Encoding Process 1, while image 450A is encoded in accordance with Encoding Process 2. As such, at least one encoded image will have been created per group.

Shown in FIG. 4B is an alternative embodiment in which two or more of the images in the same group are combined prior to encoding, such that the number of encoded images created for the group is less than the number of images that were rendered for that group. Specifically, FIG. 4B is identical to FIG. 4A, except that images 440A and 4408 are combined at the time of encoding. This results in a single encoded image 460D, whereas in FIG. 4A there were two encoded images 460A, 460B.

It remains to be described how it is decided, at step 340, which objects in the scene belong to the first subset and which objects belong to the second subset (i.e., how to decide which objects should be rendered into one or more images in group 440 as opposed to one or more images in group 450). This can be determined based on the contents of an “object database” that includes the previously described object list 430. Such an object database may be maintained in the RAM 103 and/or the storage medium 104.

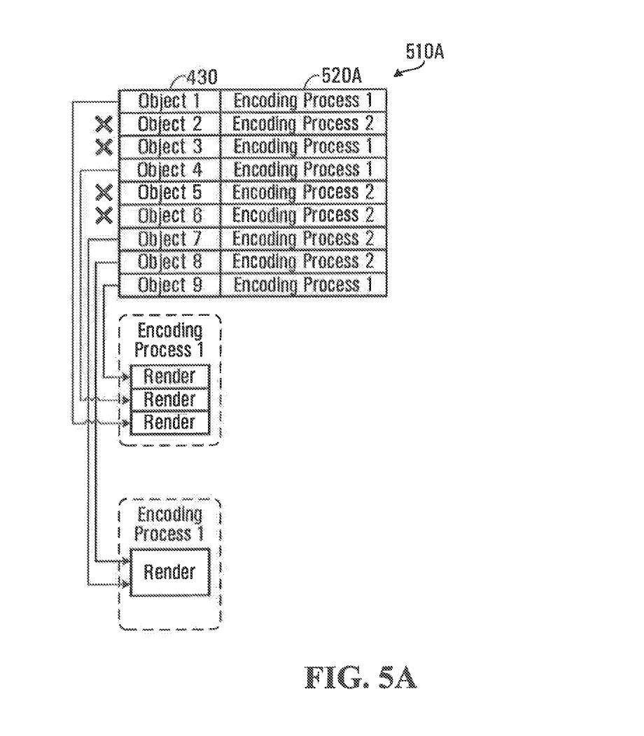

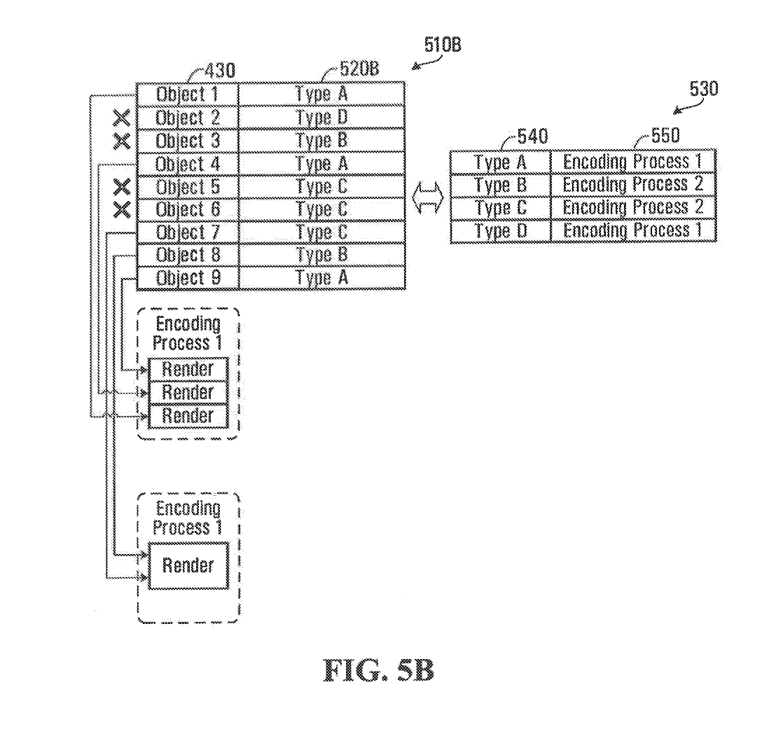

In a first embodiment, described with reference to FIG. 5A, there is shown an object database 510A (depicted as a table) with a plurality of records (depicted as rows of the table). Each of the records is associated with a particular object in the object list 430 and includes an “encoding process” field 520A. The encoding process field 520A for a given object identifies an encoding process (or compression algorithm) to be used to encode an image representing that object.

In the present example, it will be seen that objects 1, 3, 4 and 9 are to be encoded using Encoding Process 1, while objects 2, 5, 6, 7 and 8 are to be encoded using Encoding Process 2. Of course, there may be more than two encoding processes to choose from. Also, it will be understood that the association between objects and encoding processes shown in FIG. 5A has been deliberately selected for the purposes of consistency with FIG. 4A.

Alternatively, with reference to FIG. 5B, there is shown an object database 510B and an encoding process map 530. The object database 510B is depicted as a table having a plurality of records (depicted as rows of the table). Each of the records is associated with a particular object in the object list 430 and includes an “object type” field 520B. The object type field 520B for a given object identifies that object's “object type”. In this example, possible “object types” include Type A, Type B, Type C and Type a More particularly, it is seen that objects 1, 4 and 9 are associated with Type A, objects 3 and 8 are associated with Type B, objects 5, 6 and 7 are associated with Type C and object 2 is associated with Type D. The server system 100 running the video game program instructions maintains the object database 510B up to date and therefore has knowledge of the each object's type. Non-limiting example definitions of “object type” are provided later on in this specification.

For its part, the encoding process map 530 is also depicted as a table having a plurality of records depicted as rows of the table. Each of the records of the encoding process map 530 is associated with a particular object type from a universe of object types and includes an “object type” field 540 and an “encoding process” field 550. The encoding process field 550 for a given object type identifies the encoding process corresponding to the given object type. That is to say, the encoding process field 550 for a given object type identifies the encoding process to be used to encode images representing objects of that object type. In this example, possible encoding processes include Encoding Process 1 and Encoding Process 2. More particularly, it is seen that Type A and Type D object types are associated with Encoding Process 1, while Type B and Type C object types are associated with Encoding Process 2.

Those skilled in the art will appreciate that if the object database 510B is convolved with the encoding process map 530, and if one takes into account that only objects 1, 4, 7, 8 and 9 are within the game screen rendering range, one obtains the result that objects 1, 3, 4 and 9 are to be encoded using Encoding Process 1, while objects 2, 5, 6, 7 and 8 are to be encoded using Encoding Process 2. This is consistent with the association created in FIG. 5A and the illustration in FIG. 4A. Of course, this has been done deliberately to facilitate understanding.

### Examples of “Object Types”

Possible bases on which to designate a particular object as being of a particular “object type” are now described. Specifically, an object type of a given object can be conceptualized as an underlying classification, characteristic or feature of the given object, and which is shared by other objects of the same object type. Generally speaking, the object type bears a relationship to the encoding process ultimately used to encode a rendered image in which objects of that type are represented.

A variety of underlying characteristics may be used to define an object type used to discriminate amongst objects. For example, objects may be characterized according to:
image quality requirement (in which case the object type may be one of, e.g., low, medium, high, etc.);
on-screen position (in which case the object type may be one of, e.g., heads up display (HUD), onscreen action, etc.); or
in-game role (in which case the object type may be one of, e.g., character/avatar, sky, building, cloud, fire, vegetation, scoreboard, etc.);
etc.

Other examples of underlying characteristics that may be used to classify objects into different object types will appear to those of skill in the art. Also, the number of object types (i.e., the number of ways in which the underlying characteristic can be expressed) is not particularly limited.

Generally speaking, it will be appreciated that each object belongs to one of at least two object types. When an object qualifies to be of two or more “types”, it may be necessary to make a decision as to what will be the true object type for the purposes of the main game loop. This decision can be made automatically based on a priority scheme/rulebook, or it can be set (hard coded) by the video game developer.

### Examples of Encoding Processes

The encoding process used to encode the images can be implemented by a video codec, which is a device (or set of instructions) that enables or carries out or defines a video compression or decompression algorithm for digital video.

Video compression transforms an original stream of digital image data (expressed in terms of pixel locations, color values, etc.) into an output stream of digital image data that conveys the same information but using fewer bits. There is a balance to be maintained between the video quality, the quantity of the data needed to represent a given image on average (also known as the bit rate), the complexity of the encoding and decoding algorithms, the robustness to data losses and errors, the ease of editing, the ability to access data at random, the end-to-end delay, and a number of other factors. As such, many customized methods of compression exist, having varying levels of computational speed, memory requirements and degrees of fidelity (or loss).

While the above description has referred to encoding processes at a high level, it is to be understood that any encoding process can be used, depending on operational requirements. Currently available compression algorithms can differ in terms of their quality, fidelity and/or their degree of lossiness. For example, compression algorithms might be categorized as either lossy or lossless, and within each category, there are differences in terms of computational complexity, robustness to noise, etc. To be precise, non-limiting examples of a lossless or high quality encoding process (compression algorithm) include PNG, H.264 lossless and JPEG2000 lossless, to name a few non-limiting possibilities. Non-limiting examples of lossy or lower quality compression algorithms include H.264, DiVX and WMV, to name a few non-limiting possibilities. It should be understood that different compression algorithms may have the same degree of lossiness yet differ in quality. Of course, other encoder algorithms can be used without departing from the scope of the present invention.

### Game Screen Reproduction at Client Device

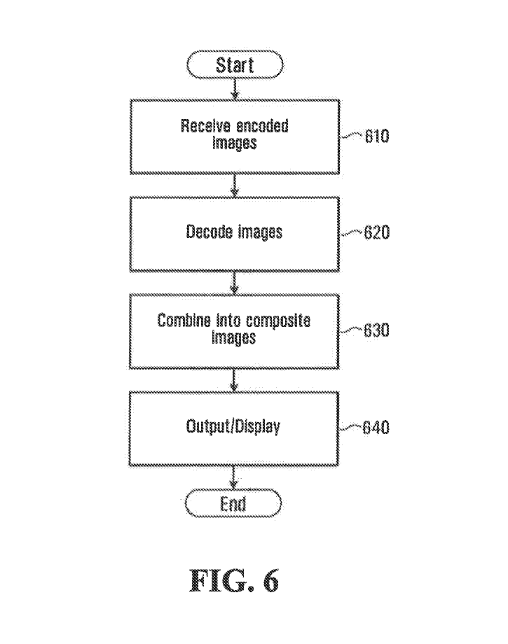

Reference is now made to FIG. 6, which shows operation of the client device associated with participant Y, which may be any of client devices 12a-e. Specifically, at step 610, the encoded images are received. At step 620, the encoded images are decoded in accordance with the decompression algorithm that is complementary to the compression algorithm used in step 360. In a non-limiting embodiment, the decompression algorithm required to decode a given image may be specified in the content of one or more packets that convey the given image. At step 630, the (decoded) images are combined in order to generate a composite image at the client device.

In the case of video frames, combining video frames may be effected by using, as an initial state of the video memory of the client device, the image conveyed by the video frame encoded using the lowest bit rate. Then, the image conveyed by the video frame encoded using the next highest bit rate is reproduced and, where a pixel with a non-zero color value exists, that pixel replaces any pre-existing pixel located at the same position in the video memory. This process repeats, until the image conveyed by the video frame encoded using the highest bit rate has been processed in a similar fashion.

Alternatively, the plural decoded images may be combined using an alpha blending technique. That is to say, each of the decoded images constitutes a layer, and some of the layers are deemed to be partially transparent by assigning an alpha value thereto, where alpha is between 0 and 1.

Finally, at step 640, the composite image is output via the output mechanism of the client device. For example, in the case of video, a composite video frame is displayed on the display of the client device. In addition, associated audio may also be played and any other output synchronized with the video frame may similarly be triggered.

### Operational Example

One benefit of employing a plurality of encoding processes can be that different objects having different underlying characteristics (e.g., objects of different object types) may be reproduced at different levels of quality on the client device. When the objects to be graphically reproduced at a lower quality are strategically chosen to be those objects for which the user is less likely to perceive image quality variations, the result may be that significantly less bandwidth is used on the network while the user experience may remain invariable (or may change only negligibly).

In a specific non-limiting example of application, consider that the heads up display (HUD) is typically motionless and constantly visible in the foreground. Thus, it may be desirable to reproduce its contents with a higher quality than the rest of the game screen and therefore it may be desirable to carry out compression of graphical elements in the HUD at a higher bit rate. For this reason, it may be beneficial to classify objects (see object database 510B in FIG. 5B) according to on-screen position, where the object type may take on one of (for simplicity) two possible values: “HUD” or “on-screen action”. Here, the encoding process map (see element 530 in FIG. 6B) may associate higher-bit-rate compression to objects that are of the “HUD” object type and lower-bit-rate compression to objects that are of the “on-screen action” object type. The effect may be unperturbed (or substantially imperceptibly perturbed) image quality at the client device, with substantial bandwidth savings.

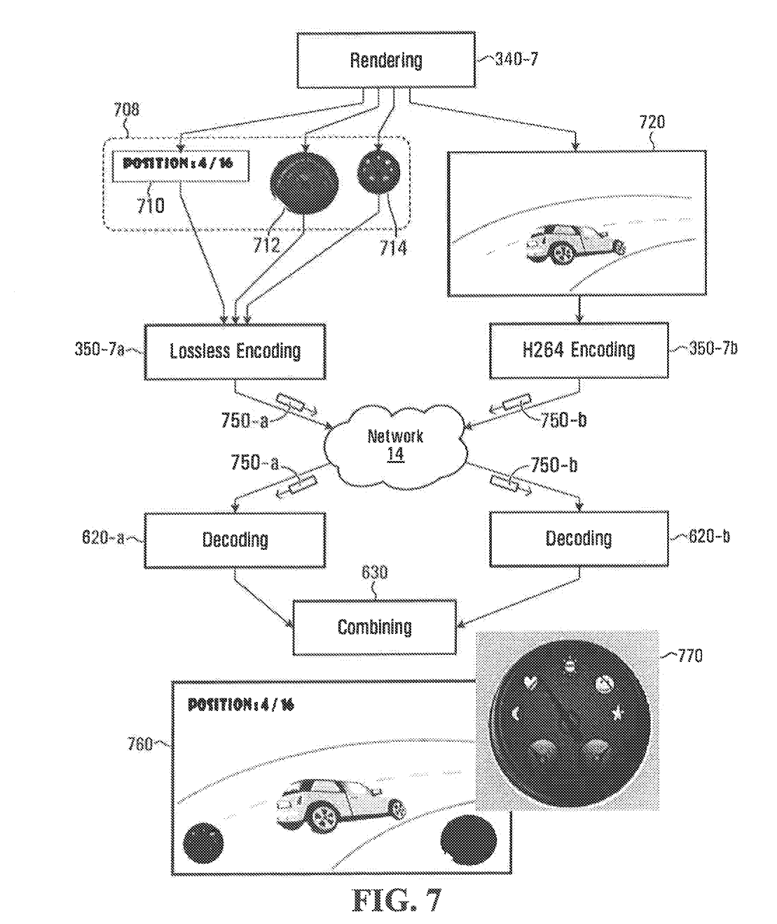

By way of illustration, consider FIG. 7, which schematically depicts the effect of steps 340-7, 350-7a, 350-7b, 620-7a, 620-7b, 630-7 and 640-7 in a non-limiting example. In the present example, there are two encoding schemes, namely “lossless encoding” and “H264 encoding”. Lossless encoding operates at a higher bit rate (and takes longer to execute) than H264 encoding but produces a clearer, crisper image. At step 340-7, two groups of images are rendered. The first group 708 includes images 710, 712, 714 and the second group includes image 720. Images 710, 712, 714 in the first group represent objects located in the player's heads-up display (HUD), namely objects of the “HUD” type. On the other hand, image 720 represents objects forming part of the on-screen action, namely objects of the “on-screen action” type.

In the present example, the on-screen action is fast-paced, which means that a fast encoding scheme is required. Also, the content is likely to change from one image to the next, which increases the bandwidth required to transmit the video information. On the other hand, the objects in the HUD do not change much, are smaller in size and are visible at all times. Thus, in this example, there is a one-to-one correspondence between object types and encoding processes. Specifically, the “HUD” type is associated with the lossless compression algorithm and the “on-screen action” type is associated with the H264 compression algorithm.

Accordingly, at step 350-7a, images 710, 712, 714 are combined and encoded using the lossless compression algorithm, resulting in the creation of a first encoded image 750-a. (It should be appreciated that in other embodiments, separate encoded images could have been created for each of the images 710, 712, 714 in the first group.) Analogously, at step 350-7b, image 720 is encoded using the H264 compression algorithm, resulting in the creation of a second encoded image 750-b. The first and second encoded images 750-a and 750-b generated at steps 350-7a and 350-7b, respectively, are transmitted to the client device over the Internet or other network 14.

At the client device, the first and second encoded images 750-a and 750-b are received. The first encoded image 750-a is decoded at step 620-a using a lossless decompression algorithm that is complementary to the lossless compression algorithm employed at step 350-7a. Analogously, the second encoded image 750-b is decoded at step 620-b using a decompression algorithm that is complementary to the H264 compression algorithm employed at step 350-7. The decoded images are combined (mixed) at step 630, resulting in the composite image 760, of which a portion is enlarged at 770 to emphasize the degree of graphical clarity in the HUD, which is comparatively greater than that of the scenery.

In another specific non-limiting example of application, it may be desirable to reproduce images of characters/avatars at a higher bit rate, while it may be acceptable to suffer some loss when reproducing images of buildings and fire, and to suffer even more loss when reproducing images of the sky, clouds and vegetation. Here, it may be beneficial to classify objects according to in-game role, where the object type may take on one of the six aforementioned values (character, building, fire, sky, cloud, vegetation). The encoding process map (see 530 in FIG. 5B) may associate higher-bit-rate compression to objects that are of the “character” type, medium-bit-rate compression to objects that are of the “buildings” or “fire” types and lower-bit-rate compression to objects that are of the “cloud”, “sky” or “vegetation” types.

Still other examples will be apparent to those of skill in the art.

While the above example has focused on the rendering of individual 2-D images of a video frame, the present invention does not exclude the possibility of rendering and encoding multiple sets of 2-D images per frame to create a 3-D effect. In addition, audio information or other ancillary information may be associated with each image and stored in a buffer or sound card memory.

Persons skilled in the art should appreciate that the above discussed embodiments are to be considered illustrative and not restrictive. Also it should be appreciated that additional elements that may be needed for operation of certain embodiments of the present invention have not been described or illustrated as they are assumed to be within the purview of the person of ordinary skill in the art. Moreover, certain embodiments of the present invention may be free of, may lack and/or may function without any element that is not specifically disclosed herein.

Those skilled in the at will also appreciate that additional adaptations and modifications of the described embodiments can be made. The scope of the invention, therefore, is not to be limited by the above description of specific embodiments but rather is defined by the claims attached hereto.

1. A method of creating and encoding images, comprising:
identifying a set of objects in a scene to be rendered;
rendering the objects into at least two groups of images, each of the groups of images comprising at least one image respective to that group;
encoding the images in each group in accordance with an encoding process common to that group; and
outputting the encoded images via an interface.

2. The method defined in claim 1, wherein the groups of images include a first group of at least one first image and a second group of at least one second image, and wherein the encoding process used to encode the at least one first image is different from the encoding process used to encode the at least one second image.

3. The method defined in claim 1, wherein the groups of images include a first group and a second group, and wherein the encoding process used to encode the images in the first group and the encoding process used to encode the images in the second group are associated with different levels of image quality.

4. The method defined in claim 1, wherein the groups of images include a first group and a second group, and wherein the encoding process used to encode the images in the first group and the encoding process used to encode the images in the second group are selected from the set consisting of: PNG, H.264 lossless, JPEG2000 lossless, H.264, DiVX and WMV.

5. The method defined in claim 1, wherein the groups of images include a first group of at least one first image and a second group of at least one second image, wherein rendering the objects comprises rendering a first subset of the objects into the at least one first image and rendering a second subset of the objects into the at least one second image.

6. The method defined in claim 5, wherein the objects in the first subset of objects are associated with a first object type and wherein the objects in the second subset of objects are associated with a second object type different from the first object type.

7. The method defined in claim 5, wherein the objects in the first subset of objects are associated with an object type in a first set of object types and wherein the objects in the second subset of objects are associated with an object type in a second set of object types.

8. The method defined in claim 7, wherein the first and second sets of object types include different object types.

9. The method defined in claim 1, wherein the groups of images include a first group of a plurality of first images and a second group of at least one second image, wherein rendering the objects comprises rendering individual objects into corresponding ones of the first images.

10. The method defined in claim 9, wherein the objects rendered into corresponding ones of the first images are associated with a common object type that is unique to the first subset.

11. The method defined in claim 6, wherein the object type of a given one of the objects is indicative of an image quality requirement of the given one of the objects.

12. The method defined in claim 11, wherein the image quality requirement of the given one of the objects is selected from the group consisting of: high, medium and low.

13. The method defined in claim 6, wherein the object type of a given one of the objects is indicative of an on-screen position of the given one of the objects.

14. The method defined in claim 13, wherein the on-screen position of the given one of the objects is selected from the group consisting of: heads up display (HUD) and on-screen action.

15. The method defined in claim 6, wherein the object type of a given one of the objects is indicative of an in-game role of the given one of the objects.

16. The method defined in claim 15, wherein the in-game role of the given one of the objects is selected from the group consisting of: character/avatar, sky, building, cloud, fire, vegetation and scoreboard.

17. The method defined in claim 11, wherein the object type is stored as a field in a memory, the method further comprising:
accessing the memory to retrieve the object type associated with each of the objects.

18. The method defined in claim 1, wherein at least one of the groups comprises a plurality of images, the method further comprising:
combining at least two of the images prior to encoding, such that the number of images after encoding is less than the number of images before encoding.

19. The method defined in claim 1, implemented by at least one server executing a video game, wherein the images are game screens of the video game.

20. The method defined in claim 1, wherein to render an object, the method further comprises retrieving object information from a memory.

21. The method defined in claim 20, wherein to render an object, the method further comprises interacting with a graphics processing unit (GPU).

22. The method defined in claim 1, wherein outputting the encoded images via the interface comprises sending the encoded images towards a client device over a network.

23. The method defined in claim 1, wherein outputting the encoded images via the interface comprises sending the encoded images towards a client device over the Internet.

24. A non-transitory computer-readable medium storing instructions for execution by at least one processor of at least one computing device, wherein execution of the instructions by the at least one processor of the at least one computing device causes the at least one computing device to implement a method of creating and encoding images, comprising:
identifying a set of objects in a scene to be rendered;
rendering the objects into at least two groups of images, each of the groups of images comprising at least one image respective to that group;
encoding the images in each group in accordance with an encoding process common to that group; and
outputting the encoded images via an interface.

25. The computer-readable medium defined in claim 24, wherein the groups of images include a first group of at least one first image and a second group of at least one second image, and wherein the encoding process used to encode the at least one first image is different from the encoding process used to encode the at least one second image.

26. The computer-readable medium defined in claim 24, wherein the groups of images include a first group and a second group, and wherein the encoding process used to encode the images in the first group and the encoding process used to encode the images in the second group are associated with different levels of image quality.

27. The computer-readable medium defined in claim 24, wherein the groups of images include a first group and a second group, and wherein the encoding process used to encode the images in the first group and the encoding process used to encode the images in the second group are selected from the set consisting of: PNG, H.264 lossless, JPEG2000 lossless, H.264, DiVX and WMV.

28. The computer-readable medium defined in claim 24, wherein the groups of images include a first group of at least one first image and a second group of at least one second image, wherein rendering the objects comprises rendering a first subset of the objects into the at least one first image and rendering a second subset of the objects into the at least one second image.

29. The computer-readable medium defined in claim 28, wherein the objects in the first subset of objects are associated with a first object type and wherein the objects in the second subset of objects are associated with a second object type different from the first object type.

30. The computer-readable medium defined in claim 28, wherein the objects in the first subset of objects are associated with an object type in a first set of object types and wherein the objects in the second subset of objects are associated with an object type in a second set of object types.

31. The computer-readable medium defined in claim 30, wherein the first and second sets of object types include different object types.

32. The computer-readable medium defined in claim 24, wherein the groups of images include a first group of a plurality of first images and a second group of at least one second image, wherein rendering the objects comprises rendering individual objects into corresponding ones of the first images.

33. The computer-readable medium defined in claim 32, wherein the objects rendered into corresponding ones of the first images are associated with a common object type that is unique to the first subset.

34. The computer-readable medium defined in claim 29, wherein the object type of a given one of the objects is indicative of an image quality requirement of the given one of the objects.

35. The computer-readable medium defined in claim 34, wherein the image quality requirement of the given one of the objects is selected from the group consisting of: high, medium and low.

36. The computer-readable medium defined in claim 29, wherein the object type of a given one of the objects is indicative of an on-screen position of the given one of the objects.

37. The computer-readable medium defined in claim 36, wherein the on-screen position of the given one of the objects is selected from the group consisting of: heads up display (HUD) and on-screen action.

38. The computer-readable medium defined in claim 29, wherein the object type of a given one of the objects is indicative of an in-game role of the given one of the objects.

39. The computer-readable medium defined in claim 38, wherein the in-game role of the given one of the objects is selected from the group consisting of: character/avatar, sky, building, cloud, fire, vegetation and scoreboard.

40. The computer-readable medium defined in claim 34, wherein the object type is stored as a field in a memory, the method further comprising:
accessing the memory to retrieve the object type associated with each of the objects.

41. The computer-readable medium defined in claim 24, wherein at least one of the groups comprises a plurality of images, the method further comprising:
combining at least two of the images prior to encoding, such that the number of images after encoding is less than the number of images before encoding.

42. The computer-readable medium defined in claim 24, wherein the images are game screens of a video game.

43. The computer-readable medium defined in claim 24, wherein to render an object, the method further comprises retrieving object information from a memory.

44. The computer-readable medium defined in claim 43, wherein to render an object, the method further comprises interacting with a graphics processing unit (GPU).

45. The computer-readable medium defined in claim 24, wherein outputting the encoded images via the interface comprises sending the encoded images towards a client device over a network.

46. The computer-readable medium defined in claim 24, wherein outputting the encoded images via the interface comprises sending the encoded images towards a client device over the Internet.

47. At least one video game server, comprising:
an interface for communication with at least one client device over a network;
a memory;
at least one processing unit configured to:
identify a set of objects in a scene to be rendered for at least one client device;
render the objects into at least two groups of images stored in the memory, each of the groups of images comprising at least one image respective to that group;
encode the images in each group in accordance with an encoding process common to that group; and
output the encoded images via the interface.

48. The at least one video game server of claim 47, wherein the at least one video game server comprises a plurality of servers, wherein at least a first one of the servers is configured to identify the set of objects and wherein at least a second one of the servers is configured to render the objects into the at least two groups of images.

49. The at least one video game server of claim 48, wherein the at least a second one of the servers is also configured to encode the images and to output the encoded images.

50. The at least one video game server of claim 48, wherein the at least a second one of the servers comprises at least one graphics processing unit (GPU) configured to render the objects into the at least two groups of images.

51. The at least one video game server defined in claim 47, wherein the groups of images include a first group of at least one first image and a second group of at least one second image, and wherein the encoding process used to encode the at least one first image is different from the encoding process used to encode the at least one second image.

52. The at least one video game server defined in claim 47, wherein the groups of images include a first group and a second group, and wherein the encoding process used to encode the images in the first group and the encoding process used to encode the images in the second group are associated with different levels of image quality.

53. The at least one video game server defined in claim 47, wherein the groups of images include a first group and a second group, and wherein the encoding process used to encode the images in the first group and the encoding process used to encode the images in the second group are selected from the set consisting of: PNG, H.264 lossless, JPEG2000 lossless, H.264, DiVX and WMV.

54. The at least one video game server defined in claim 47, wherein the groups of images include a first group of at least one first image and a second group of at least one second image, wherein to render the objects the at least one processing unit is configured to render a first subset of the objects into the at least one first image and to render a second subset of the objects into the at least one second image.

55. The at least one video game server defined in claim 54, wherein the objects in the first subset of objects are associated with a first object type and wherein the objects in the second subset of objects are associated with a second object type different from the first object type.

56. The at least one video game server defined in claim 54, wherein the objects in the first subset of objects are associated with an object type in a first set of object types and wherein the objects in the second subset of objects are associated with an object type in a second set of object types.

57. The at least one video game server defined in claim 56, wherein the first and second sets of object types include different object types.

58. The at least one video game server defined in claim 47, wherein the groups of images include a first group of a plurality of first images and a second group of at least one second image, wherein to render the objects the at least one processing unit is configured to render individual objects into corresponding ones of the first images.

59. The at least one video game server defined in claim 58, wherein the objects rendered into corresponding ones of the first images are associated with a common object type that is unique to the first subset.

60. The at least one video game server defined in claim 55, wherein the object type of a given one of the objects is indicative of an image quality requirement of the given one of the objects.

61. The at least one video game server defined in claim 60, wherein the image quality requirement of the given one of the objects is selected from the group consisting of: high, medium and low.

62. The at least one video game server defined in claim 55, wherein the object type of a given one of the objects is indicative of an on-screen position of the given one of the objects.

63. The at least one video game server defined in claim 62, wherein the on-screen position of the given one of the objects is selected from the group consisting of: heads up display (HUD) and on-screen action.

64. The at least one video game server defined in claim 55, wherein the object type of a given one of the objects is indicative of an in-game role of the given one of the objects.

65. The at least one video game server defined in claim 64, wherein the in-game role of the given one of the objects is selected from the group consisting of: character/avatar, sky, building, cloud, fire, vegetation and scoreboard.

66. The at least one video game server defined in claim 60, the object type is stored as a field in the memory, the at least one processing unit being configured to access the memory to retrieve the object type associated with each of the objects.

67. The at least one video game server defined in claim 47, wherein at least one of the groups comprises a plurality of images, the at least one processing unit being further configured to combine at least two of the images prior to encoding, such that the number of images after encoding is less than the number of images before encoding.

68. The at least one video game server defined in claim 47, wherein the images are game screens of a video game.

69. The at least one video game server defined in claim 47, wherein to render an object, the at least one processing unit retrieving object information from the memory.

70. The at least one video game server defined in claim 69, wherein to render an object, the at least one processing unit is configured to interact with a graphics processing unit (GPU).

71. The at least one video game server defined in claim 47, wherein the encoded images are sent via the interface towards a client device over a network.

72. The at least one video game server defined in claim 47, wherein the encoded images are sent via the interface towards a client device over the Internet.
